(19) United States
(12) Patent Application Publication
(10) Pub. No.: US 2017/0343124 A1
(43) Pub. Date: Nov. 30, 2017

(54) Shut-Off Body For A Valve And Valve Comprising Said Type Of Shut-Off Body

(71) Applicant: A. Raymond et Cie SCS, Grenoble (FR)

(72) Inventor: Jochen Zimmer, Görwihl (DE)

(73) Assignee: A. Raymond et Cie SCS, Grenoble (FR)

(21) Appl. No.: 15/517,604

(22) PCT Filed: Oct. 7, 2015
(86) PCT No.: PCT/EP2015/001965

§ 371 Date: Apr. 7, 2017

(30) Foreign Application Priority Data
Oct. 9, 2014 (DE) 10 2014 014 740.1

(51) Int. Cl. F16K 15/14; F16K 7/17; F16K 27/02; F16K 15/02; B60S 1/52; F16H 57/027

(52) U.S. Cl. CPC F16K 15/144; F16K 27/0236; F16K 15/141; F16K 15/023; F16K 7/17; F16H 57/027; B60S 1/52

(57) ABSTRACT

The invention relates to a shut-off body (1) for a valve which comprises a support ring (2) and an elastic valve membrane (3) which is arranged inside the support ring and which closes the inside of the support ring, which valve membrane is essentially flat.

The invention relates to a shut-off body for a valve which comprises a support ring and an elastic valve membrane arranged inside the support ring and which closes the interior of the support ring. The invention also relates to a valve with such a shut-off body.

DE 100 47 199 A1 teaches a shut-off body for a valve which comprises on O-ring and a membrane connected to the O-ring. The membrane comprises openings distributed over its circumference which can free a connection conduit on an outer cylindrical wall of the valve.

Furthermore, U.S. Pat. No. 5,529,280 teaches a shut-off body for a valve which comprises a support ring and an elastic valve membrane which is arranged inside the support ring and closes the interior of the support ring. The valve membrane arranged inside the support ring comprises a bent section (reference number 3 in the figures of U.S. Pat. No. 5,529,280) which directly follows the support ring and comprises a sealing rib 9.

Given this background, the invention had the basic problem of suggesting a shut-off body for a valve which makes a good seal of the valve even under slight pressure forces.

This problem is solved by the shut-off body according to claim 1 and by the valve according to claim 12. Advantageous embodiments are reproduced in the subclaims and the following specification.

The invention starts from the basic concept that in a shut-off body with an elastic valve membrane a good seal of a valve using this shut-off body can be achieved even under low pressure forces if the valve membrane of the shut-off body is essentially flat, which means in particular the shape of the valve membrane if the shut-off body is considered separately and removed from the valve. The invention is therefore different from the construction of the shut-off body like the one used in U.S. Pat. No. 5,529,280 whose elastic membrane is designed to be curved in some areas and therefore generates a return force facing away from the sealing surface which subtracts from the sealing of the valve seat and therefore requires higher sealing forces.

The shut-off body according to the invention for a valve comprises a support ring and an elastic valve membrane arranged inside the support ring. The task of the support ring is substantially to hold (support) the valve membrane. The valve membrane can be manipulated by the support ring. The valve membrane can also be arranged at a location predetermined for it inside the valve by arranging the support ring on a predetermined location inside of valve comprising the shut-off body in accordance with the invention. Furthermore, the valve membrane can also be moved inside the valve by moving the support ring inside the valve, for example, from a position which it assumes in a closed position into one (or more) positions which it assumes in one of the open positions of the valve.

The elastic valve membrane used in the shut-off body of the invention consists in particular of an elastomer. The elastic valve membrane consists especially preferably of ethylene-propylene-diene rubber (EPDM), nitric rubber (NBR), fluorocarbon rubber (FKN), acrylate rubber ACM) or fluorosilicone rubber (FVMQ). The selection of the material can also depend, in addition to the adjusting of suitable properties of elasticity, also on the fluid which is to be sealed against. Therefore, for example, for a sealing against water the use of EPDM or NBR is recommended while the use of FKM is frequently used for sealing against fuels. It is also conceivable to use thermoplastic elastomers (TPE). It is likewise conceivable to manufacture the elastic valve membrane from latex.

The use of an elastic valve membrane makes it possible to expand the valve membrane in the closed position of the valve and according to a preferred embodiment of the invention. As a result of the expanding of the elastic valve membrane a return force is produced inside the valve membrane which can be advantageously used as a supplementary sealing force. In such a preferred embodiment the shut-off body is not only pressed by a shutting-off force introduced from the outside but in a supplementary manner by the return force of the expanded valve membrane against the valve seat.

The valve membrane of the invention is essentially flat. In a preferred embodiment this shape is conditioned in that the valve membrane is held in a pre-tensioned manner in the support ring. As a supplement or according to another preferred embodiment this shape also results from the fact that the valve membrane has a very low thickness and/or a high elasticity so that it is not suitable for three-dimensional shapes. The essentially flat form of the valve membrane has the further advantage that in the preferred embodiment in which the valve membrane is expanded to close the valve seat, a good and uniform sealing action can be generated. This would be counteracted, for example, by the presence of sealing beads like those provided in U.S. Pat. No. 5,529,280 since the valve membrane cannot be expanded in the area of such a sealing bead.

In a preferred embodiment the valve membrane has a thickness of more than 0.1 mm, especially preferably of more than 0.3 mm. In an especially preferred embodiment the valve membrane has a thickness of less than 1 mm. In addition to the selection of material, the selection of the thickness is a way of adjusting the stiffness of the valve membrane.

In a preferred embodiment the support ring has a height, measured in the direction of the thickness of the valve membrane, which is at least two times thicker than the thickness of the valve membrane. The support ring is especially preferably used to manipulate the valve membrane inside the valve, for example when the valve should be opened. The support ring can also be used to place the valve membrane well inside the position provided for it inside the valve. To this end it is advantageous if the support ring has a shape with which it can be firmly and suitably attached in a valve. This can be especially readily achieved if the support ring does not drop below a certain thickness. Since according to the invention in particular a thin valve membrane is preferred, the height of the support ring is especially preferably twice, quite especially preferably three times, four times or five times thicker than the thickness of the valve membrane.

In a preferred embodiment the support ring is an O-ring.

In a preferred embodiment the support ring has a round or elliptical cross section in a plane which contains the direction of thickness of the valve membrane and extends in a radial direction of the shut-off body. This applies in particular for the preferred embodiment in which the support ring is an O-ring. In a preferred embodiment the shut-off body has a round or an elliptical shape, for example with a circular or elliptical ring-shaped support ring. In this embodiment the radial direction of the shut-off body corresponds to one of the directions running radially outward from the center or one of the focal points of the ellipse. However, even other embodiments are conceivable in which the support ring is designed, for example, to be rectangular or quadratic or has another shape. In such embodiments the radial direction of the shut-off body is understood to be the direction which is outwardly directed from the center of the surface of the cross-sectional surface of the shut-off body in the plane in which the shut-off body essentially extends. A round or elliptical cross-sectional form of the support ring makes possible in particular a simple manufacture of the shut-off body, for example by form pressing or injection molding.

In a preferred embodiment the valve membrane is connected to the support ring at the location at which the support ring has its maximum extension in the radial direction. In the case of a support ring with the previously described round or elliptical cross-sectional shape in the plane which contains the direction of the thickness of the valve membrane and extends in a radial direction of the shut-off body, in particular in the case of the preferred use of an O-ring as support ring, the valve membrane is especially preferably arranged in the plane of symmetry of such a support ring. Here, the plane of symmetry designates the plane in which the shape of the support ring above the plane corresponds to the shape of the support ring below the plane. This arrangement of the valve membrane relative to the support ring also simplifies the manufacturing of the shut-off body. Alternatively, embodiments are conceivable in which the valve membrane is connected to the support ring at the position of the maximum extension of the support ring in the direction of thickness. Such structural shapes are advantageous if the valve membrane is to be built firmly in a special manner into a valve by the support ring.

In a preferred embodiment the support ring and the valve membrane are constructed in one piece. As a result, the shut-off body can be readily manufactured in one manufacturing step, for example by form pressing or by injection molding. Alternatively, embodiments are conceivable in which the valve membrane is manufactured separately from the support ring and is connected to it, for example by a joining method, in particular preferably by adhering or welding. In such an embodiment the valve membrane is especially preferably held in the support ring in a pre-tensioned manner. As a result of the pre-tensioning of the separately manufactured valve membrane built into the support ring the desired rigidity of the valve membrane can be adjusted.

The using of a support ring to which the valve membrane is fastened allows the selection of a very thin valve membrane which would collapse by itself but retains a given shape by its connection with the support ring.

In a preferred embodiment the shut-off body was manufactured by form pressing. In an alternative embodiment the shut-off body was produced by injection molding.

In a preferred embodiment reinforcement elements are provided in the support ring and/or in the valve membrane. Such reinforcement elements can be, for example, fibers. The providing of reinforcement elements is especially advantageous for the support ring if the support ring is to be used to hold the valve membrane firmly in a certain position inside the valve.

In a preferred embodiment the valve membrane comprises at least partially an anti-adhesion coating. The use of an anti-adhesion coating makes it possible for the valve membrane to separate more easily from the valve seat when the valve is to be opened. It is especially preferred that the valve membrane is provided continuously with an anti-adhesion coating at least on one side. A lacquer based on silicone and/or PTFE (Teflon) is especially suitable as an anti-adhesion coating.

In a preferred embodiment the support ring, especially a support ring with a round cross-sectional shape, constitutes the element of the shut-off body which is outermost in the radial direction. The support ring comprises, especially preferably when viewed in the radial direction, no projections or continuations arranged on the outside.

In a preferred embodiment the valve membrane closes the interior of the support ring completely so that no passage of fluid through the support ring is possible. However, embodiments are conceivable in which the valve membrane has holes in some positions. It is essential for the shut-off body that the valve membrane is tight and has no holes in the areas in which it should close a fluid opening. This is, for example, the case when the valve membrane rests on a crown-shaped valve seat, for the area of the valve membrane which rests on the crown and the areas of the valve membrane located inside this area. However, in order to achieve the sealing effect it is not necessary here. Areas of the valve membrane which, for example, directly border the support ring are to be designed continuously without holes. However, embodiments are preferred in which the valve membrane entirely closes the interior of the support ring since a start is made from the fact that such shut-off body can be more easily manufactured. Furthermore, the introduction of holes would produce weaknesses in the material which might cause a loosening of the valve membrane from the support ring.

The valve according to the invention comprises a shut-off body according to the invention. This creates a valve in which a good tightness of the valve can be produced even with slight pressure forces on the shut-off body.

In a preferred embodiment the valve comprises a fluid opening which is closed by the valve membrane in a closed position of the valve, wherein the fluid opening comprises a valve seat in the form of an edge, especially preferably of a crown-shaped edge against which the valve membrane is held in the closed position. The edge and the crown form a sealing surface in this embodiment against which the valve membrane is held in the closed position and as a result seals the fluid opening.

In an especially preferred embodiment, in the closed position of the valve the circumferential line and which the valve membrane is connected to the support ring is arranged closer to the fluid opening than the part of the valve membrane which is held against the edge so that the valve membrane is expanded relative to the non-built-in form of the shut-off body. In such an embodiment the edge of the valve seat projects in such a manner that the support ring can be arranged closer to the fluid opening than the surface of the ends of the valve seat, which surface is to be sealed by the valve membrane. The shut-off body of the invention is folded, as it were, over the edge or the crown of the valve seat, as a result of which the valve membrane is expanded.

In a preferred embodiment in an open position of the valve the valve membrane can be lifted off the edge of the valve seat by the fluid pressure of the fluid coming through the fluid opening onto the valve membrane whereas the support ring is held fast on an element of the valve housing. As a consequence, a valve can be created whose opening is automatically brought about by adjusting the fluid pressure. If the fluid is brought from the fluid opening onto the valve membrane whose fluid pressure is below a predetermined threshold, then the valve remains closed in this preferred embodiment because the contact force holding the valve membrane in the closed position is greater than the fluid pressure. If the fluid pressure rises above the previously set measurement, than the valve membrane is lifted from the edge of the valve seat so that the fluid can flow between the edge of the valve seat and the valve membrane to one or more outlet openings of the valve.

In a preferred embodiment the shut-off body can freely move (“free floating valve”) in a valve chamber. Such an embodiment can be used in the case of a fluid flow from a first fluid opening emptying into the chamber for moving the shut-off body away from this fluid opening and as a consequence to make it possible for the fluid to flow out of this fluid opening into the chamber while in the case of a fluid flowing through another fluid opening into the chamber the shut-off body can be pressed against the valve seat of the first fluid opening and can consequently close this fluid opening.

In a preferred embodiment of the valve of the invention the valve membrane of the shut-off body is expanded in a closed position of the valve relative to the position which the valve membrane assumes inside the shut-off body in an open position of the valve. The expansion of the valve membrane, especially the expansion of the valve membrane by an annular body, for example by the edge or the crown of a valve seat makes possible a good seal even if the shut-off body is slightly tilted inside the valve in comparison to an ideal position which it would assume in the closed state, or, for example, the valve is agitated or, however, non-uniform pressure conditions develop.

The valve according to the invention can be produced with low costs. This also takes place in particular due to the fact that the shut-off body can be produced in a simple manner, for example by form pressing. A valve with a low structural height can also be realized starting from a shut-off body with a valve membrane which is essentially flat in the non-built-in state.

The pre-tensioning of the valve membrane allows a good sealing action to be generated even in the case of rough surfaces of the valve seat since the expanded valve membrane adapts to the shape of the valve seat.

The shut-off body according to the invention and the valve according to the invention are especially preferred in fluid lines of an automobile and especially preferred in fluid lines used for windshield wiper water. Such lines should be sealed in the end area, in particular in the vicinity of the nozzles from which the windshield wiper water should be discharged in order to prevent the entrance of foreign bodies or air or other fluids into the line system of the windshield wiper liquid and/or to avoid a backflow of the fluid. However, frequently only low pressures are present in these areas which could be used for sealing a shut-off body. Frequently, only ambient pressure is present at the outflow side. Also, frequently only ambient pressure is present in the lines in the line system for the windshield wiper liquid (until the fluid is loaded with pressure in order to eject it via the nozzle). However, at the same time shut-off bodies to be driven should be avoided in the area of the nozzle in order not to make the line system for the windshield wiper liquid too expensive. That means that a valve must be used which achieves a good sealing action even when using low sealing forces. At the same time, the sealing forces should be selected to be so low that the valve can be opened by a slight elevation of the pressure of the fluid in the line and that the windshield wiper liquid can be brought out. All this is made possible by the shut-off body according to the invention and by the valve according to the invention.

A comparable application is found in the ventilation of transmissions and in the dewatering of transmissions for which the shut-off body according to the invention and the valve according to the invention are used with special preference. Such valves should prevent the entrance of fluids into the transmission. On the other hand, such valves should open when fluid should exit out of the transmission. The fluid pressures in this area of use are as a rule ambient pressures. Even here shut-off bodies which are to be driven should not be used. Therefore, it is also advantageous here to use a shut-off body which can produce a good sealing action with low pressures but at the same time upon the occurrence of a liquid with low fluid pressures in a fluid opening it can free this opening in order to make possible the desired discharge of the fluid.

The invention is explained in detail in the following using only exemplary embodiments of the invention. In the drawings:

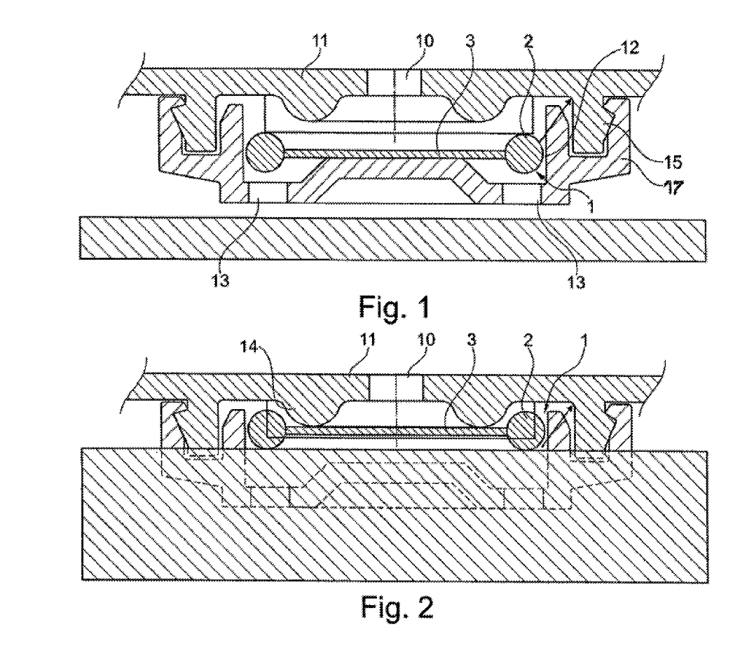

FIG. 1 shows a cross section through a dewatering opening of a motor vehicle transmission with a shut-off body fastened to it in a first operating situation in a schematic, sectional side view;

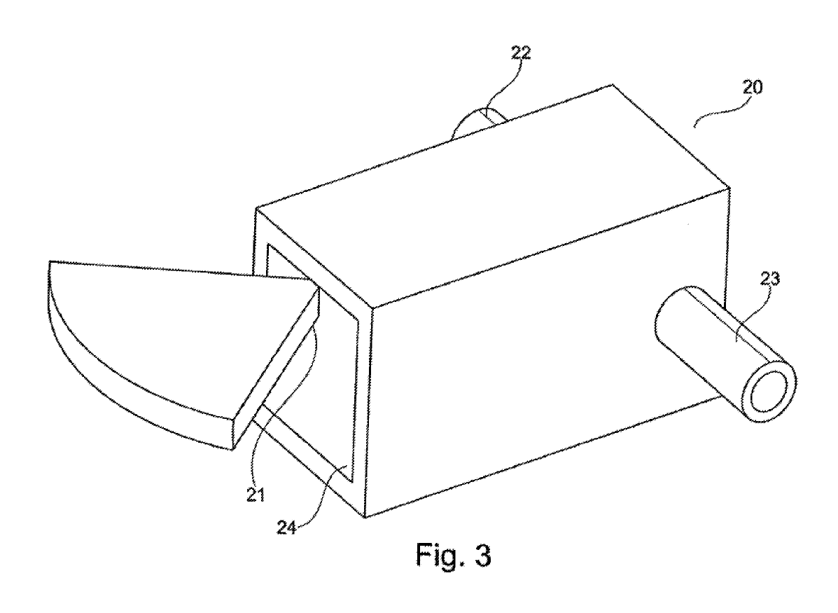

FIG. 2 shows the opening of the motor vehicle transmission according to FIG. 1 in a second operating situation, also in a sectional side view;

FIG. 3 shows a perspective, schematic view of an outlet nozzle for windshield wiper liquid;

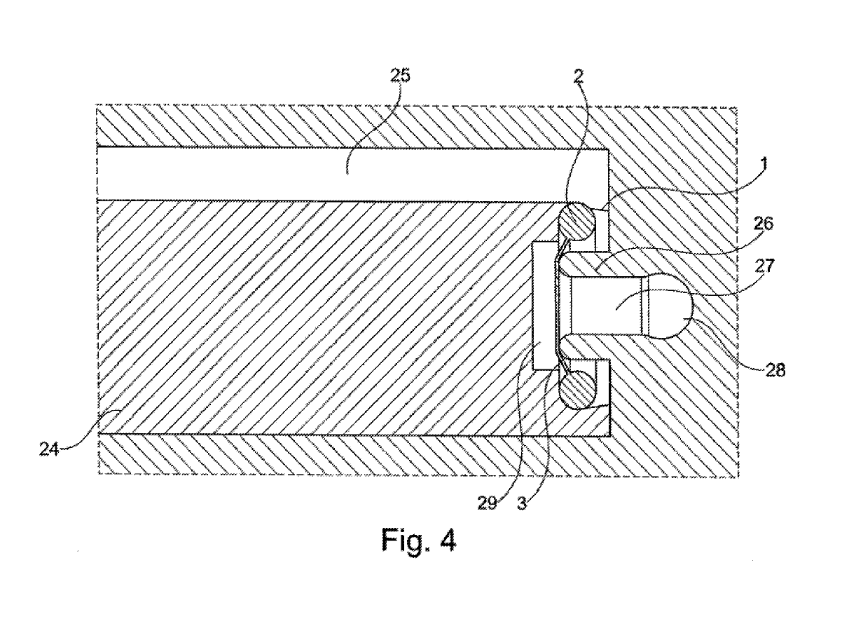

FIG. 4 shows a sectional, schematic view of the outlet nozzle according to FIG. 3 in a first operating situation;

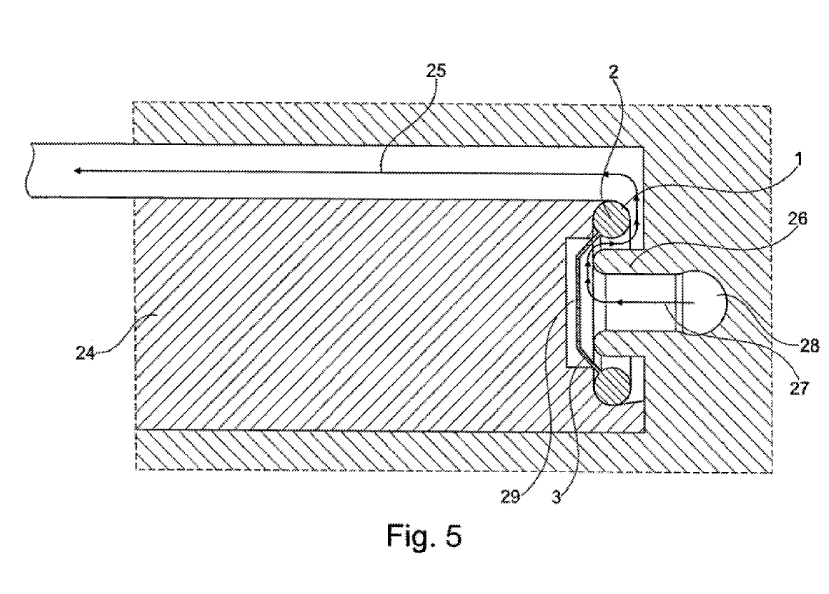

FIG. 5 shows a sectional, schematic view of the outlet nozzle according to FIG. 3 in a second operating situation;

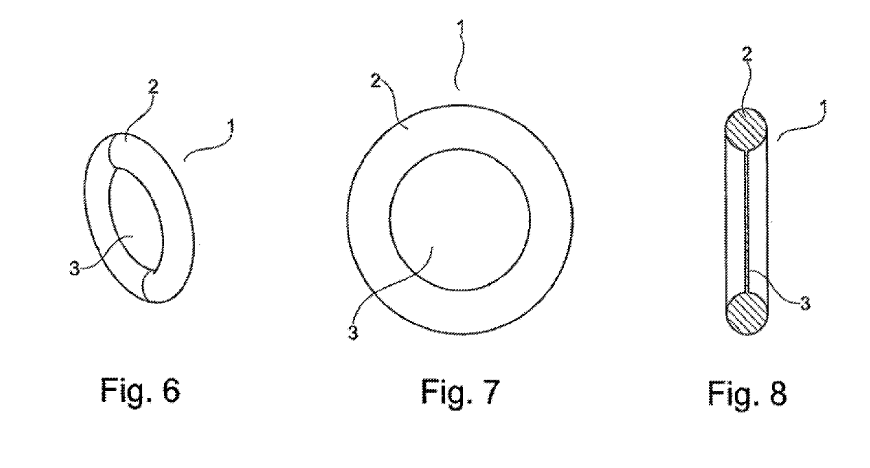

FIG. 6 shows a schematic view of a shut-off body according to the invention;

FIG. 7 shows a top view onto the shut-off body according to the invention and according to FIG. 6; and

FIG. 8 shows a sectional view of the shut-off body according to the invention and according to FIG. 6.

The shut-off body 1 shown in FIG. 6 comprises a support ring 2 constructed as an O-ring and an elastic valve membrane 3 arranged inside the support ring 2, which valve membrane closes the interior of the support ring 2. As is apparent from FIGS. 6, 7 and 8, The valve membrane is essentially flat in the completed state of the shut-off body 1.

As is apparent from FIG. 8, the support ring 2 has a round cross-sectional form in a plane which contains the direction of thickness of the valve membrane 3 and extends in the radial direction of the shut-off body 1. The FIGS. 6 to 8 show that the valve membrane 3 is connected to the support ring 2 at the location at which the support ring 2 has its maximum extension in the radial direction. FIGS. 4 and 5 show that during the inclusion of such a shut-off body in a valve, torsional forces on the shut-off body can result in that the support ring 2 rotates and the connection of the valve membrane to the support ring is moved into a position which no longer corresponds to the maximum extension of the support ring 2 in the radial direction in this inclusion position.

The FIGS. 6, 7 and 8 show that the support ring 2 and the valve membrane 3 are in one piece. This results from the fact that the shut-off body was manufactured by form pressing.

In the use of the shut-off body in a dewatering valve for the transmission housing of a motor vehicle shown in the FIGS. 1 and 2 the valve according to the invention is constructed as a valve with a freely movable shut-off body 1. FIG. 1 shows a first operating situation of the valve according to the invention. Here, the shut-off body 1 is held by its own weight in a first position in which it frees the dewatering opening 10 of the transmission housing 11 (shown only in section) of a motor vehicle. Fluid, especially liquid can exit from the dewatering opening 10 and exit via a slot 12 on the shut-off body 1 out of discharge openings 13.

In the operating situation shown in FIG. 2 the shut-off body 1 is moved by fluid entering via the outlet openings 13 in the direction of the dewatering opening 10. As a result, the valve membrane is bought in contact with a crown-shaped valve seat 14 arranged in the area of the dewatering opening 10. The valve membrane 3 seals the dewatering opening 10 by resting on the crown of the valve seat 14. When the fluid entering through the outlet openings 13 presses the support ring closer to the dewatering opening 10 than the part of the valve membrane 3, which is held against the edge, the valve membrane 3 is expanded in comparison to the non-built-in form of the shut-off body 1. This produces return forces which lead to an increase of the sealing forces and therefore to a better seal of the dewatering opening 10. In addition, it makes possible the expansion of the valve membrane 3, the compensation of rugosities or uneven areas of the crown-shaped valve seat and nevertheless results in a good sealing action.

The valve shown in FIGS. 1 and 2 comprises a valve cover 17 which is screwed onto a threading 15 of the transmission housing 11. The outlet openings 13 are provided in the valve cover 17. A recess 16 also provided in the valve cover 17 carries the shut-off body 1 in the embodiment shown in FIG. 1 and prevents the shut-off body 1 from (partially) closing the exit openings 13.

The outlet nozzle 20 shown in FIG. 3 for bringing out windshield wiper water comprises the nozzle outlet 21 from which the windshield wiper water exits. Furthermore, the outlet nozzle 20 comprises an inlet conduit 22 and an outlet conduit 23 by which the outlet nozzle 20 can be connected to a circuit for windshield wiper water. An insert element 24 is provided inside the outlet nozzle 20. The insert element 24 forms a conduit 25 through which windshield wiper water can flow to the outlet nozzle 21. Furthermore, the insert element 24 holds the support ring 2 of the shut-off body 1 firmly in the outlet nozzle 20. In the structural situation shown in FIG. 4 the valve membrane 3 is pressed against a crown-shaped valve seat 26 of a fluid opening 27. The valve membrane is slightly expanded here in contrast to the non-built-in form of the shut-off body 1. As a consequence, the valve membrane can compensate uneven areas, deviations of tolerance in the manufacture of the crown-shaped valve seat 26 and rough surfaces of the valve seat 26 and can seal the fluid opening 27 well. As a consequence, it prevents a backflow of the fluid present in the chamber 28. The inlet conduit 22 and the outlet conduit 23 border the chamber and therefore connect the chamber 28 to the windshield wiper water circuit.

If the fluid pressure is raised in the windshield wiper water circuit and therefore also inside the chamber 28, the valve membrane is lifted off from the crown-like valve seat 26 and pressed into a chamber 29 of the insert element 24. As a consequence, it makes it possible for the fluid to flow between the crown-shaped valve seat 26 and the valve membrane 3 and past the support ring 2 into the conduit 25.

1. A shut-off body for a valve, which comprises a support ring and an elastic valve membrane arranged inside the support ring, which membrane closes the interior of the support ring, characterized in that the valve membrane is essentially flat.

2. The shut-off body according to claim 1, characterized in that the valve membrane has a thickness of less than 1 mm.

3. The shut-off body according to claim 1, characterized in that the support ring has a height, measured in the direction of the thickness of the valve membrane, which is at least two times thicker than the thickness of the valve membrane.

4. The shut-off body according to claim 1, characterized in that the support ring has a round cross section in a plane which contains the direction of thickness of the valve membrane and extends in a radial direction of the shut-off body.

5. The shut-off body according to claim 4, characterized in that the valve membrane is connected to the support ring at the location at which the support ring has its maximum extension in the radial direction.

6. The shut-off body according to claim 1, characterized in that the support ring and the valve membrane are one piece.

7. The shut-off body according to claim 6, characterized in that the shut-off body is manufactured by form pressing.

8. The shut-off body according to claim 1, characterized in that reinforcement elements are provided in the support ring and/or in the valve membrane.

9. The shut-off body according to claim 1, characterized in that the valve membrane is held pre-tensioned in the support ring.

10. The shut-off body according to claim 1, characterized in that the valve membrane at least partially includes an anti-adhesion coating.

11. Valve with a shut-off body according to claim 1.

12. The valve according to claim 11, characterized by a fluid opening which is closed by the valve membrane in a closed position of the valve, and which comprises a valve seat in the form of an edge against which the valve membrane is held in the closed position.

13. The valve according to claim 12, characterized in that in the closed position the circumferential line on which the valve membrane is connected to the support ring is arranged closer to the fluid opening than the part of the valve membrane which is held against the edge so that the valve membrane is expanded relative to the non-built-in form of the shut-off body.

14. The valve according to claim 13, characterized in that in an open position of the valve the valve membrane can be lifted off the edge by the fluid pressure of the fluid coming through the fluid opening onto the valve membrane while the support ring is held fast on an element of the valve housing.

15. The valve according to claim 11, characterized in that the shut-off body is a freely movable shut-off body.

16. The shut-off body according to claim 2, characterized in that the support ring has a height, measured in the direction of the thickness of the valve membrane, which is at least two times thicker than the thickness of the valve membrane, and the support ring has a round cross section in a plane which contains the direction of thickness of the valve membrane and extends in a radial direction of the shut-off body.

17. The shut-off body according to claim 2, characterized in that the support ring and the valve membrane are one piece.

18. The shut-off body according to claim 17, characterized in that reinforcement elements are provided in the support ring and/or in the valve membrane.

19. The shut-off body according to claim 18, characterized in that the valve membrane is held pre-tensioned in the support ring.

20. The shut-off body according to claim 19, characterized in that the valve membrane at least partially includes an anti-adhesion coating.
